(19) United States
(12) Patent Application Publication
(10) Pub. No.: US 2009/0108585 A1
(43) Pub. Date: Apr. 30, 2009

(54) FLUID TURBINE WITH BLADE ASSEMBLY DRIVEN BY FLUID

(76) Inventor: Sheng-Chu TAI, Kaohsiung (TW)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/925,367

(22) Filed: Oct. 26, 2007

(51) Int. Cl. F03D 9/00

(52) U.S. Cl. 290/55

(57) ABSTRACT

A turbine using fluid as a driving power to generate electricity includes a posts a generator assembly mounted on the post and a blade assembly operably connected to the generator assembly to drive the generator assembly to rotate to produce electricity. The blade assembly has multiple gates each spaced apart from each other with respect to the post so as to balance weight of the blade assembly to the post. Each gate has multiple blades pivotally mounted inside the gate and an actuator to alternately close/open gaps between adjacent blades to optimally use power of a fluid passing through the blades.

### TECHNICAL FIELD

The present invention relates to a fluid turbine, and more particularly to a fluid turbine with a blade assembly driven by fluid.

### BACKGROUND ART

A wind turbine used for generating electricity normally is built in an area where the average wind velocity is 4.5 r/sec and is composed of a support, a stairway, a generator and a blade assembly. The support erects directly from the ground and has a length of about 40 to 60 meters, and the stairway is mounted inside the support. The generator weights about 75 tons and is mounted on top of the support. The blade assembly is rotatably mounted on a side of the generator to drive the generator to operate so as to generate electricity. A computerized recorder is also built inside the generator to record the wind speed and the operation of the generator. The blade assembly normally has multiple blades each having a length of 20 meters or more and a center of the blade assembly is away from the ground for about 40 to 60 meters.

In general, the higher the larger wind speed is. However, due to the un-stability of the wind in the air, the fan assembly is normally mounted at a height where the average wind velocity is around 4.5 m/sec.

The wind turbine now available in the market suffers from drawbacks that hinder the optimal output performance of the blade assembly.

The blade assembly is mounted on a side of the generator which is mounted on top of the support such that the overall weight of the blade assembly might tilt the wind turbine. In order to overcome the tilting situation, a counter-weight device has to be provided to offset the weight of the blade assembly, which increases the difficulty of the wind turbine design and the overall production cost.

Further, the blade assembly is mounted at a height of 40 to 60 meters above the ground with each blade span of 20 meters. Therefore, once the blade assembly is mounted on top of the support, only a certain range of the wind can be used by the blade assembly. Wind in other heights has only little effect on the blade assembly, which causes a waste of the natural resource.

To overcome the shortcomings, the present invention tends to provide a fluid turbine to mitigate the aforementioned problems.

### SUMMARY OF THE INVENTION

The primary objective of the present invention is to provide a fluid turbine with a blade assembly and that utilizes the natural fluid in the optimal efficiency.

In order to accomplish the aforementioned objective, a fluid turbine has a post, a generator assembly mounted on the support and a blade assembly connected to the generator assembly and has multiple blades equally spaced apart from each other such that the weight of the blade assembly is evenly distributed with respect to the post.

The blade assembly has multiple frames each having multiple blades pivotally and immediately arranged to an adjacent blade inside the frame and an actuator connected to the blades to alternatively close/open gaps between the blades so that the blades are able to pivot relative to the frame to optimally use the wind.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a fluid turbine with a blade assembly in accordance with the present invention;

FIG. 2 is an enlarged operational perspective view of the fluid turbine in FIG. 1;

FIG. 3 is an operational top view of the fluid turbine in FIG. 1 showing the movement of the blade assembly of the fluid turbine;

FIG. 4 is a perspective view of another embodiment of a fluid turbine with a blade assembly in accordance with the present invention;

FIG. 5 is an enlarged operational perspective of the fluid turbine in FIG. 4;

FIG. 6 is an operational top view of the fluid turbine in FIG. 1 showing the movement of the blade assembly of the fluid turbine;

FIG. 7 is an operational side view of the fluid turbine in FIG. 1 showing that the fluid turbine is immersed in water so as to utilize the current of the water as the driving power to rotate the blade assembly of the fluid turbine; and

FIG. 8 is an operational side view of an electricity-generating device with multiple fluid turbines in accordance with the present invention.

### BEST MODE FOR CARRYING OUT THE INVENTION

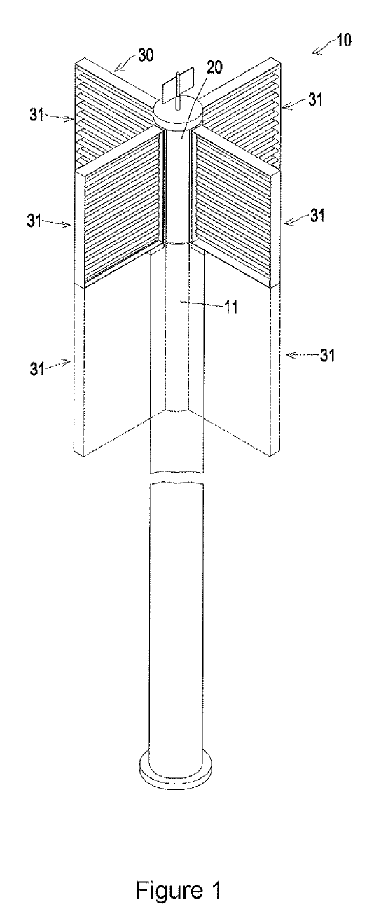

With reference to FIGS. 1 to 3, a fluid turbine (10) in accordance with the present invention includes a post (11), a generator assembly (20) and a blade assembly (30).

The post (11) may be mounted directly on the ground or may be mounted on a support normally away from the ground for 40 to 60 meters.

The generator assembly (20) may be mounted on the bottom or the top of the post (11) for easy maintenance and includes components necessary for producing electricity with the driving power of fluid, the wind or water Due to the structure of the generator assembly (20) may be conventional, so detailed description thereof is omitted. In this embodiment of the present invention, the generator assembly (30) is mounted on top of the post (11).

The blade assembly (30) comprises multiple gates (31) evenly spaced apart from each other and rotatably mounted on top of the post (11). Each gate (31) is securely mounted on an outer periphery of the generator assembly (20) which is rotatable relative to the post (11). When the gates (31) are driven by wind or water to rotate relative to the post (11), the generator assembly (20) is also driven to rotate relative to the post (11) and generate electrical power.

Each gate (31) has a frame (32), multiple blades (33) pivotally mounted inside the frame (32) and immediately close to one another inside the frame (32) and an actuator (34) mounted on a bottom side of the frame (32) to control pivotal rotation of the blades (33). A vane (21) is mounted on top of the generator assembly (20) to detect wind or water directions and to transmit the wind direction information to a microprocessor mounted inside the generator assembly (20) as well as the actuator (34) to control a tilting angle of the blades (33). Accordingly, the microprocessor inside the generator assembly (20) is able to control the tilting angle of the blades (33) via the actuators (34). In this preferred embodiment, the actuator (34) comprises a step-motor and a linkage device mounted in the frame (32) and connected to the blades (33). When the step motor is switched on, the tilting angle of the blades (33) may be changed with the transmission of the linkage device to optimally suit the fluid direction.

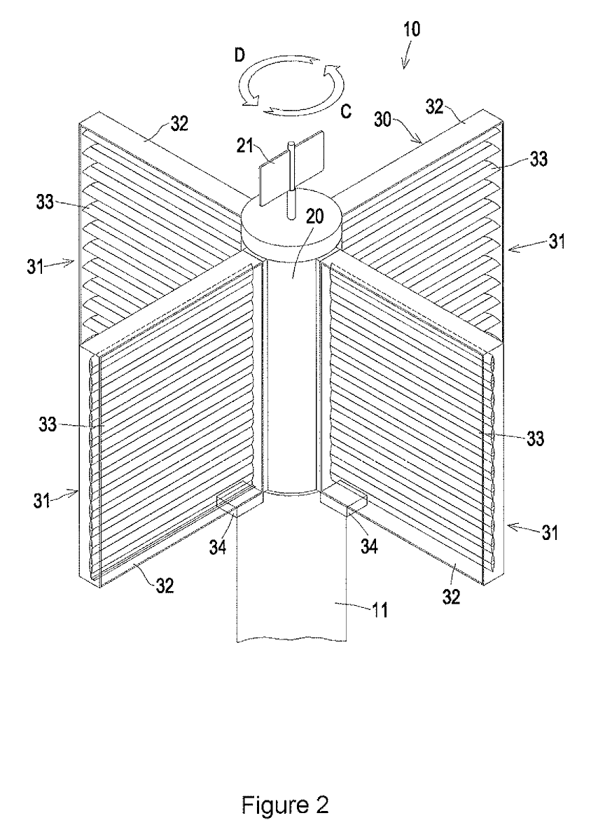

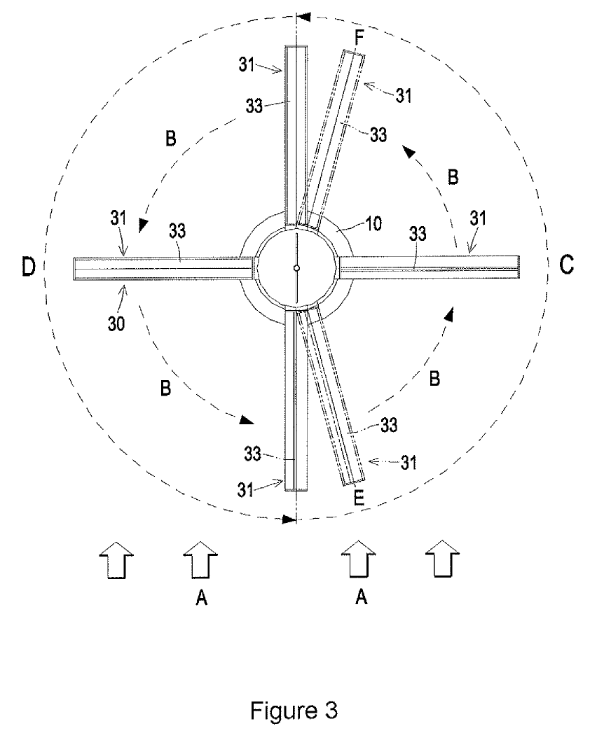

With reference to FIGS. 2 and 3, when wind is blowing in a direction as designated by arrow A in the drawing and multiple gates (31), four in this embodiment, are rotated in a direction as designated by arrow B, the vane (21) picks up the wind direction information and sends the information to the microprocessor inside the generator assembly (20) to activate the actuators (34). Thus the blades (33) at point C are accordingly closed to optimally use the wind and the blades (33) at point D are entirely opened to reduce resistance to the rotation of the blade assembly (30). When the blades (33) are entirely opened, the wind is able to freely flowing through gaps between the blades (33) and the resistance to the rotation of the blade assembly (30) is minimized. As the blades (33) are entirely closed, the overall area of each gate (31) of the blade assembly (30) facing the wind is maximized such that the wind power is effectively utilized.

Due to the provision of the actuator (34) for controlling the pivotal rotation of the blades (33), the open-close rotation of the blades (33) may be completed within micro-seconds or delayed for a period of time. When the gate (31) is at the position C, the entire blades (33) are closed so as to optimally utilize the wind power. When the blades (33) are moving from position C toward position D where the blades (33) of the gate (31) are closed, the open pivotal rotation of the blades (33) may also be completed within microseconds or delayed for a period of time. The same situation applies to the closed pivotal rotation of the blades (33) moving from the position D to positions E and C.

With reference to FIGS. 1 and 2, the gates (31) are longitudinally arranged along the longitudinal axis of the post (11) such that the blade assembly (30) extend its contact area with the wind. That is, due to the longitudinal extension of the gates (31), the blade assembly (30) may take advantage of wind in a greater range (length). In addition, the blades (33) are arranged inside each of the gate (31) in a matrix format vertical to the longitudinal axis of the post (11) so as to form a pattern similar to that of a sun shade.

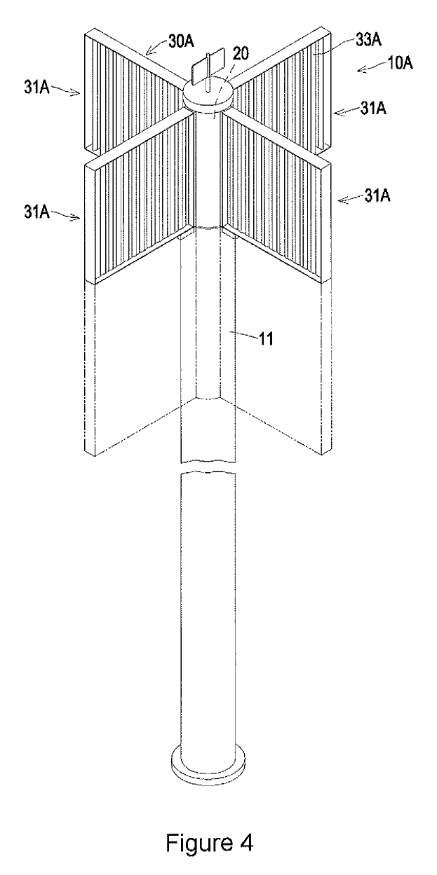

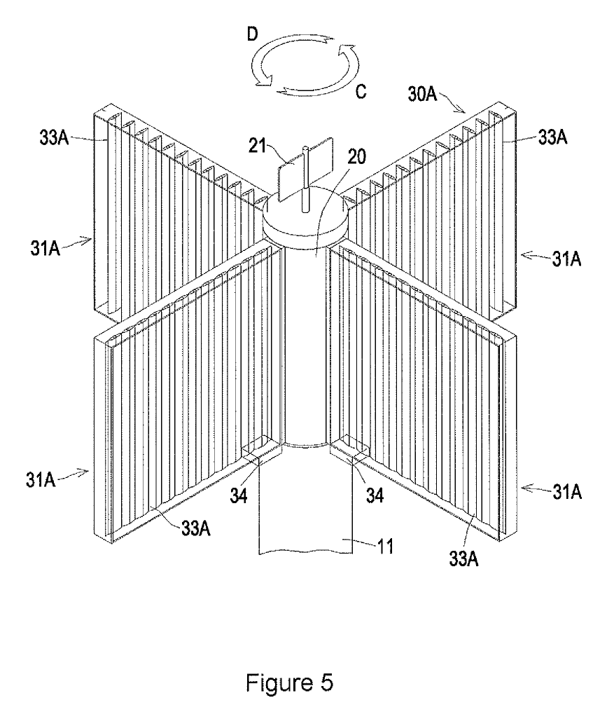

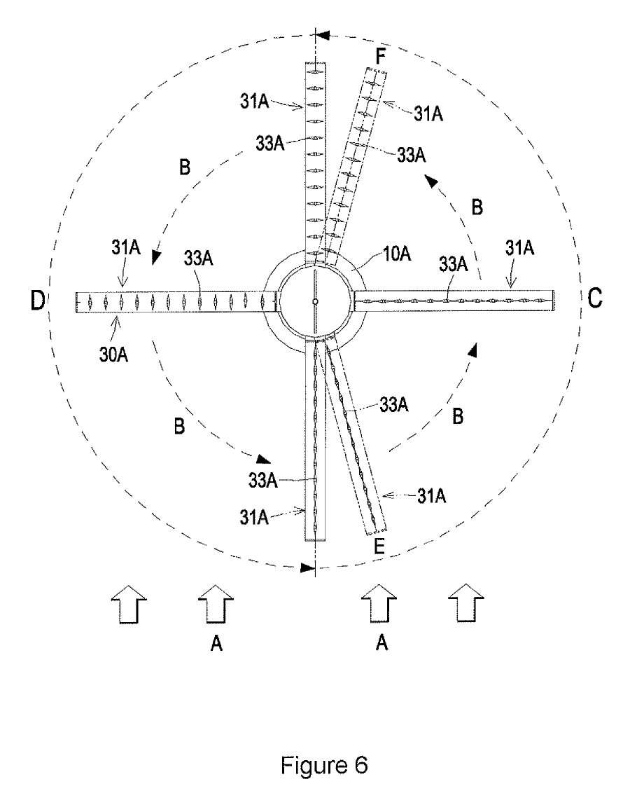

With reference to FIGS. 4 to 6, in another embodiment, the blade assembly (30A) of the fluid turbine (10A) is operated in a format similar to that of the first embodiment except that the blades (33A) on the gates (31A) of the blade assembly (30A) are arranged in a matrix format parallel to the longitudinal axis of the post (11) and formed a different sun shade.

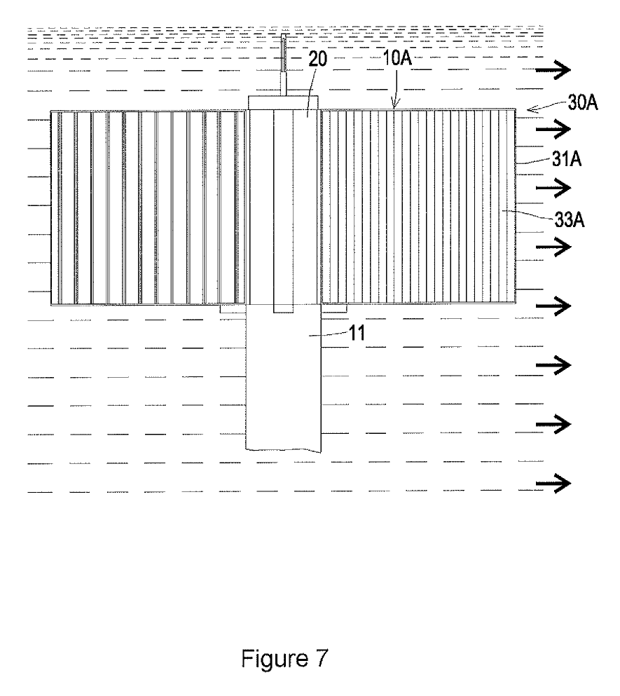

With reference to FIG. 7, in practice, the turbine (10A) in accordance with the present invention may also be used within water. That after placing the turbine (10A) inside a water, the water current may be treated as the driving force to drive the blade assembly (30) to rotate.

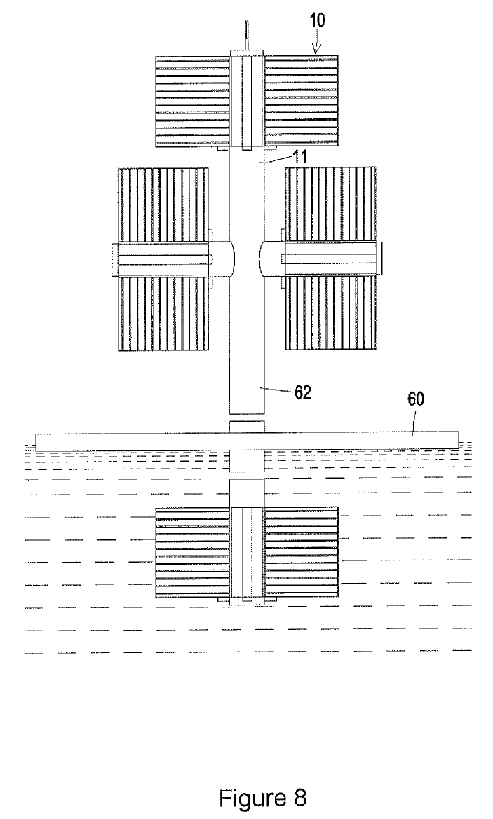

With reference to FIG. 8, an electricity-generating device with turbines (10) in accordance with the present invention may comprise a platform (60), a support (62) and multiple turbines (10). The platform (60) can be arranged on and floats above the sea, and the support (62) is securely mounted on the top of the platform (60) and has a height of about 40 to 60 meters. The turbines (10) are attached to the support (62) in different manners. One of the turbines (10) is attached to the top of the support (62), and one is attached to the support (62) under the platform (60) and is immersed inside the water. The others are attached to the support (62) in a lateral direction. Accordingly, the turbines (10) can be driven by multiple fluid sources and in different directions, such that the efficiency of generating electrical power is improved.

In summary, either wind or water may be used as the driving power to drive the fluid turbine (10,10A) in accordance the present invention, and the blade assembly (30,30A) of the (10,10A) has the following advantages to optimally use the natural resource, the fluid dynamic power.

The gates (31,31A) of the blade assembly (30,30A) are centrally mounted on and evenly distributed relative to the post (11) and are equally spaced apart from each other, so that the weight of the turbine (10,10A) is evenly distributed and the tilting of the wind turbine (10,10A) can be prevented.

Furthermore, due to the longitudinal extension of gates (31,31A) with the blades (33,33A) along the longitudinal axis of the post (11), wind in a larger scale may still have influence on the blade assembly (30,30A) so as to effectively use the wind to generate electricity.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fluid turbine for generating electricity power comprising
a post;
a generator assembly mounted on the post; and
a blade assembly connected to the generator assembly to drive the generator assembly to rotate to produce electricity and comprising
multiple gates securely connected to the generator assembly and each spaced apart from each other with respect to the post and each gate having
multiple blades pivotally mounted inside the gate and having gaps defined between the blades; and
an actuator mounted on the gate and connected to the blades to alternately close/open the gaps between the blades to optimally use power of a fluid passing through the blades.

2. The turbine as claimed in claim 1, wherein the blades in each gate are arranged vertical to a longitudinal axis of the post.

3. The turbine as claimed in claim 2 further comprising a vane mounted on a top of the post to sense direction of fluid and connected to the actuators on the gates of the blade assembly for controlling pivotal rotation of the blades on the gates.

4. The turbine as claimed in claim 3, wherein each gate has a frame and the blades of each gate are pivotally mounted inside a corresponding frame; and
the actuator of each gate is mounted at a bottom of the frame of the gate.

5. The turbine as claimed in claim 1, wherein the blades in each gate are arranged parallel to a longitudinal axis of the post.

6. The turbine as claimed in claim 5 further comprising a vane mounted on a top of the post to sense direction of fluid and connected to the actuators on the gates of the blade assembly for controlling pivotal rotation of the blades on the gates.

7. The turbine as claimed in claim 6, wherein each gate has a frame and the blades of each gate are pivotally mounted inside a corresponding frame; and
the actuator of each gate is mounted at a bottom of the frame of the gate.

8. The turbine as claimed in claim 1 further comprising a vane mounted on a top of the post to sense direction of fluid and connected to the actuators on the gates of the blade assembly for controlling pivotal rotation of the blades on the gates.

9. The turbine as claimed in claim 8, wherein each gate has a frame and the blades of each gate are pivotally mounted inside a corresponding frame; and
the actuator of each gate is mounted at a bottom of the frame of the gate.

10. The turbine as claimed in claim 1, wherein each gate has a frame and the blades of each gate are pivotally mounted inside a corresponding frame; and
the actuator of each gate is mounted at a bottom of the frame of the gate.
